(19) United States
(12) Patent Application Publication
(10) Pub. No.: US 2018/0159304 A1
(43) Pub. Date: Jun. 7, 2018

(54) PIPE MATERIAL AND PRODUCTION METHOD THEREFOR

(71) Applicant: DENSO CORPORATION, Kariya-city (JP)

(72) Inventors: Masayuki TAMURA, Kariya-city (JP); Yuji KAJI, Kariya-city (JP); Yoshinori DOI, Handa-shi (JP); Shinya TANAKA, Tokyo (JP); Atsushi YOSHIDA, Saitama-shi (JP)

(21) Appl. No.: 15/828,927

(22) Filed: Dec. 1, 2017

(30) Foreign Application Priority Data
Dec. 2, 2016 (JP) 2016-235315
Nov. 15, 2017 (JP) 2017-219944

(51) Int. Cl. H01T 13/32; H01T 21/02; B32B 15/01; H01T 13/39

(52) U.S. Cl. CPC H01T 13/32; H01T 13/39; B32B 15/01; H01T 21/02

(57) ABSTRACT

A pipe material used as a discharge electrode of a spark plug for an internal combustion engine comprises an outer layer made of a Ni-based alloy, an inner layer made of a Pt-based alloy provided inside the outer layer, and an intermediate layer provided between the outer layer and the inner layer.

### CROSS REFERENCE TO RELATED APPLICATIONS

This application is based on and claims the benefit of priority from Japanese Patent Application 2016-235315 filed on Dec. 2, 2016, and Japanese Patent Application 2017-219944 filed on Nov. 15, 2017, the disclosures of which are incorporated in their entirety herein by reference.

### BACKGROUND OF THE INVENTION

### Technical Field of the Invention

The present disclosure relates to, for example, a pipe material used as a discharge electrode of a spark plug for an internal combustion engine, and a production method therefor.

### Related Art

Japanese Unexamined Patent Publication No. 2016-51636 (hereinafter, referred to as Publication 1) discloses a spark plug which comprises an annular ground electrode. A discharge gap is formed between the inner circumferential surface of the ground electrode and the outer circumferential surface of the center electrode.

### SUMMARY

Publication 1 discloses an annular ground electrode which is formed by bonding an annular electrode base material made of a Ni-based alloy with a noble metal layer provided over the inner circumferential surface thereof made of a single material such as Pt or Ir, or an alloy thereof.

A pipe material serving as a ground electrode is required to have high performance and high reliability together with the center electrode. In particular, it is necessary to improve the bonding reliability. Regarding spark plug electrodes which undergo intensive cooling/heating cycles associated with starting and stopping of the engine, thermal stress is repeatedly generated between layers, and issues such as cracking and delamination tend to occur (the bonding reliability is low).

An example embodiment of the present disclosure aims to provide a multilayer pipe material having high bonding reliability.

Example embodiments of the present disclosure are a pipe material comprising an outer layer made of a Ni-based alloy, an inner layer made of a Pt-based alloy provided inside the outer layer, and an intermediate layer provided between the outer layer and the inner layer, and a production method therefor.

### BRIEF DESCRIPTION OF THE DRAWINGS

Other aspects of the present disclosure will be elucidated through the description of embodiments based on the drawings listed below.

In the accompanying drawings:

FIG. 1 is a schematic cross-sectional view of a pipe material described in the first embodiment of the present disclosure.

FIG. 2 is an enlarged cross-sectional image of the pipe material described in the first embodiment.

FIG. 3 is an enlarged cross-sectional image of a pipe material not according to the present disclosure.

FIG. 4 is a schematic cross-sectional view of a pipe material described in the second or third embodiment of the present disclosure.

FIG. 5 is an enlarged cross-sectional image of the pipe material described in the second embodiment.

### DETAILED DESCRIPTION OF THE PREFERRED EMBODIMENTS

### First Embodiment

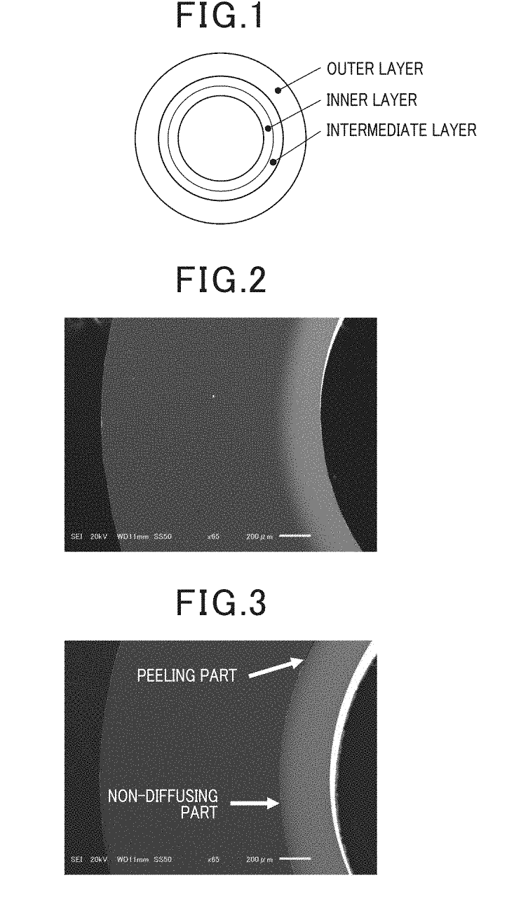

A first embodiment of the present disclosure relates to a pipe material comprising an outer layer made of a Ni-based alloy, an inner layer made of a Pt-based alloy provided inside the outer layer, and an intermediate layer provided between the outer layer and the inner layer (FIG. 1). In the pipe material of the first embodiment, the intermediate layer has a composition including Au, Ni, Ag, Pd, or Pt in addition to the component(s) of the outer layer and the outer layer. Further, in the pipe material of the first embodiment, the intermediate layer has a composition including one of the combinations of Ag and Pd, Pd and Ni, or Pt and Ni in addition to the component(s) of the outer layer and the outer layer.

The Ni-based alloy may be, for example, Inconel 600 or Inconel 601 manufactured by Special Metals Corporation. The Pt-based alloy may be, for example, 90 Pt 10 Ni (mass %), or 74.4 Pt 20 Ir 5.6 Ni (mass %).

The method of producing a pipe material according to the first embodiment includes a plating step, a combining step, a processing step, a heat treatment step, a hole forming step, and a cutting step.

The plating step is a step of forming, over the inner surface (inner circumferential surface) of a pipe material made of a Ni-based alloy corresponding to the outer layer, or over the outer surface (outer circumferential surface) of a round bar made of a Pt-based alloy corresponding to the inner layer, a plating layer of Au, Ni, Ag, Pd, or Pt, or two plating layers of a combination of Ag and Pd, two plating layers of a combination of Pd and Ni, or two plating layers of a combination of Pt and Ni.

The combining step is a step of combining the pipe material and the round bar, one of which is provided with plating layer(s), such that the round bar is positioned inside a hole part of the pipe material.

The processing step is a step of bringing the combined pipe material and round bar into close contact with each other.

The heat treatment process is a process of bonding the pipe material and the round bar brought into close contact by heating them at a certain temperature (for example, 900° C. to 1265° C.) for a certain time (for example, 0.5 to 6 hours) in a vacuum or inert gas atmosphere. Alternatively, the heat treatment process is a process of bonding the pipe material and the round bar brought into close contact by performing hot isostatic pressing at a certain temperature (for example, 800° C. to 1200° C.) and under a certain pressure (for example, 30 to 180 MPa) for a certain time (for example, 0.5 to 6 hours) in an inert gas atmosphere such as an Ar gas atmosphere.

The hole forming step is a step of forming a hole in the round bar which is bonded to the pipe material, by mechanical means, to turn it into a pipe material.

The cutting step is a step of cutting the pipe material provided with a hole.

In the plating step, a known method can be applied as the plating means, and methods such as electrolytic plating, electroless plating, vapor deposition, are sputtering are suitable.

Next, in the combining step, the pipe material and the round bar, one of which is provided with plating layer(s), are combined such that the round bar is positioned inside the hole of the pipe material. For example, the round bar is inserted into the hole of the pipe material.

In the processing step, the combined pipe material and round bar are brought into close contact with each other. The processing may be carried out using, for example, a swaging machine. The combined pipe material and round bar are inserted through a set of dies in the swaging machine which reciprocate while rotating. The pipe material is pressurized in the diametrical direction so that its outer diameter is reduced and the pipe material and the round bar are brought into close contact. Alternatively, the process may be a drawing process which reduces the outer diameter of the pipe material using a drawing die.

Next, in the heat treatment step, for example, the pipe material and the round bar brought into close contact are bonded together by heating them at a certain temperature in a vacuum or inert gas atmosphere such as Ar gas atmosphere. The heating temperature is preferably 900° C. to 1265° C., and more preferably 1150° C. to 1265° C.

Alternatively, the heat treatment process is a process of bonding the pipe material and the round bar brought into close contact by performing hot isostatic pressing at a certain temperature (for example, 800° C. to 1200° C.) and under a certain pressure (for example, 30 to 180 MPa) for a certain processing time (for example, 0.5 to 6 hours) in an inert gas atmosphere such as an Ar gas atmosphere.

In the heat treatment step, the plating layer diffuses into the two adjacent surfaces and forms an intermediate layer. The components of the outer layer, the inner layer, and the plating layer are diffused into the intermediate layer, so that it has a composition including the components of each layer. Even when the plating comprises two layers of a combination of Ag and Pd, two layers of a combination of Pd and Ni, or two layers of a combination of Pt and Ni, since the components of the outer layer, the inner layer, and the plating layers are diffused into the intermediate layer, it has a composition including the components of each layer. Since the constituent elements of the plating layer have good diffusibility with a Ni-based alloy and a Pt-based alloy, it is possible to obtain a pipe material having high bonding reliability with little or no non-diffusing parts as compared with a pipe material that does not comprise the plating layer.

In particular, when Au or Pd is contained in the plating layer, since these components (Au, Pd) and Ni, which is an outer layer component, form a low melting point phase and further promote diffusion, a pipe material with an even higher bonding reliability can be obtained.

Next, in the hole forming step, a multilayer pipe material is obtained by forming a hole in the round bar which is diffusion bonded to the pipe material, by mechanical means. Next, in the cutting step, the multilayer pipe material is cut with a wire saw or the like.

According to the pipe material of the first embodiment of the present disclosure, since the plating layer is provided in the plating step, diffusion of the inner layer (Pt-based alloy) and the outer layer (Ni-based alloy) is promoted in the heat treatment step, and good bonding can be obtained (FIG. 2). On the other hand, when the plating layer is not provided, partial bonding failure (peeling or non-diffusion) may be observed (FIG. 3).

### Second Embodiment

A second embodiment of the present disclosure relates to a pipe material comprising an outer layer made of a Ni-based alloy, an inner layer made of a Pt-based alloy provided inside the outer layer, and an intermediate layer provided between the outer layer and the inner layer. In the pipe material of the second embodiment, the intermediate layer is a layer made of any one of Pd, a Pt—Ni alloy, and a Pd—Ni alloy. The outer layer and the intermediate layer are diffusion bonded, and the intermediate layer and the inner layer are diffusion bonded. That is, the outer layer and the intermediate layer are integrated via a diffusion layer, and the intermediate layer and the inner layer are integrated via a diffusion layer.

The intermediate layer is a second pipe material having a hollow circular cross section and made of any one of Pd, a Pt—Ni alloy, and a Pd—Ni alloy. Whereas the linear expansion coefficient of the inner layer (Pt-based alloy) is about 9×10 K⁻¹ and the linear expansion coefficient of the outer layer (Ni-based alloy) is about 16×10 K⁻¹, the intermediate layer (Pd, Pt—Ni alloy, Pd—Ni alloy) has a linear expansion coefficient of 12×10 K⁻¹, which is between the linear expansion coefficients of the former two (the inner layer and the outer layer).

The method of producing a pipe material according to the second embodiment includes a combining step, a processing step, a heat treatment step, a hole forming step, and a cutting step.

In the combining step, the first pipe material corresponding to the outer layer, the second pipe material corresponding to the intermediate layer, and the round bar corresponding to the inner layer are combined such that the second pipe material is located inside a hole part of the first pipe material and the round bar is located inside a hole part of the second pipe material. The first pipe material is a pipe material having a hollow circular cross section and made of a Ni-based alloy. The second pipe material is a pipe material having a hollow circular cross section and made of any one of Pd, a Pt—Ni alloy, and a Pd—Ni alloy. The round bar is a bar having a circular cross section and made of a Pt-based alloy.

In the processing step, the combined first and second pipe materials and round bar are brought into close contact with each other.

The heat treatment process is a process of bonding the first and second pipe materials and the round bar brought into close contact by heating them at a certain temperature (for example, 900° C. to 1265° C.) for a certain time (for example, 0.5 to 6 hours) in a vacuum or inert gas atmosphere. The heating temperature in the heat treatment step is preferably 1050° C. to 1265° C. Alternatively, the heat treatment process is a process of bonding the first and second pipe materials and the round bar brought into close contact by performing hot isostatic pressing at a certain temperature (for example, 800° C. to 1200° C.) and under a certain pressure (for example, 30 to 180 MPa) for a certain time (for example, 0.5 to 6 hours) in an inert gas atmosphere such as an Ar gas atmosphere.

The hole forming step is a step of forming a hole in the round bar which is bonded to the pipe material, by mechanical means, to turn it into a pipe material.

The cutting step is a step of cutting the pipe material provided with a hole.

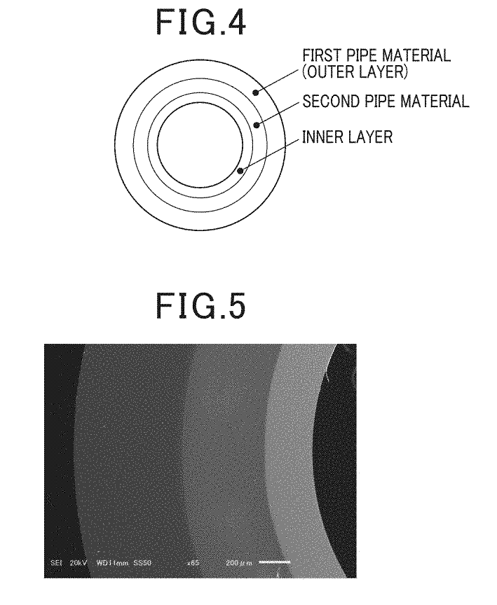

In the pipe material according to the second embodiment of the present disclosure, the second pipe material made of any one of Pd, a Pt—Ni alloy, and a Pd—Ni alloy is inserted as the intermediate layer so that the gap expected to be formed at the time of heating in the heat treatment step can be reduced (FIGS. 4 and 5). That is, as described above, since the linear expansion coefficient of the intermediate layer is set to be between the value of the linear expansion coefficient of the inner layer and the value of the linear expansion coefficient of the outer layer, the difference in expansion between the outer layer and the intermediate layer, and the difference in expansion between the intermediate layer and the inner layer become smaller than those in the case where this intermediate layer is not provided. As a result, gap formation is further suppressed, and diffusion bonding is promoted.

### Third Embodiment

The third embodiment of the present disclosure is a pipe material in which the intermediate layer is composed of two layers. The first intermediate layer is provided inside the outer layer, and the second intermediate layer is provided between the first intermediate layer and the inner layer. The first intermediate layer is a layer having a composition including Au, Cu, or Ni in addition to the components of the outer layer and the second intermediate layer. The second intermediate layer is a layer made of any one of Pd, a Pt—Ni alloy, and a Pd—Ni alloy. In addition, the second intermediate layer and the inner layer are diffusion bonded to each other. The outer layer and the second intermediate layer are integrated via the first intermediate layer, and the second intermediate layer and the inner layer are integrated via a diffusion layer.

The method of producing a pipe material according to the third embodiment comprises, in addition to the steps of the production method of the second embodiment, a plating step before the combining step.

In the plating step, a plating layer of Au, Cu, or Ni is provided over the inner surface of the first pipe material made of a Ni-based alloy corresponding to the outer layer, or over the outer surface of the second pipe material having a hollow circular cross section made of Pd, a Pt—Ni alloy, or a Pd—Ni alloy corresponding to the second intermediate layer.

The plating layer thus formed diffuses into the two adjacent surfaces in the heat treatment step so as to form the first intermediate layer. The components of the outer layer, the second intermediate layer, and the plating layer are diffused into the first intermediate layer, so that it has a composition including the components of each layer. In the heat treatment step, for example, heat treatment may be performed at a certain temperature (for example, 900° C. to 1265° C.) in vacuum. The heating temperature in the heat treatment step is preferably 1050° C. to 1265° C. Alternatively, the heat treatment process may be a process of performing hot isostatic pressing at a certain temperature (for example, 800° C. to 1200° C.) and under a certain pressure (for example, 30 to 180 MPa) for a certain time (for example, 0.5 to 6 hours) in an inert gas atmosphere such as an Ar gas atmosphere.

According to the pipe material of the third embodiment of the present disclosure, since the second intermediate layer (Pd, a Pt—Ni alloy, or a Pd—Ni alloy) is provided, the difference in the linear expansion coefficients can be buffered. Further, since the plating layer is provided, the diffusion of the second intermediate layer (Pd, a Pt—Ni alloy, or a Pd—Ni alloy) and the outer layer (Ni-based alloy) is promoted, and as a result, diffusion bonding is promoted.

As described above, according to the example embodiments of the present disclosure, the bonding is improved by promoting interlayer diffusion, and a multilayer pipe material having high bonding reliability can be provided. For example, when this pipe material is used as an electrode of a spark plug, the intermediate layer buffers the thermal stress between the outer layer and the inner layer, and problems such as cracking and delamination due to repeated thermal stress caused by starting and stopping of the engine can be suppressed. In addition, since the heat treatment temperature required for diffusion can be lowered, grain growth does not proceed in the outer layer and the inner layer, and troubles such as grain boundary cracking can also be suppressed.

### Example 1

A pipe material having a hollow circular cross section made of Inconel 601 corresponding to the outer layer and a round bar having a circular cross section made of 90PtNi (mass %) corresponding to the inner layer were prepared. The outer diameter and the inner diameter of the pipe material were set to be 6.4 mm and 4.0 mm, respectively, and the diameter of the round bar was set to be 3.8 mm.

A plating layer made of one of the following elements and having one of the following thicknesses was formed on the outer surface of the round bar by electrolytic plating (plating step).
Example 1-1 Au, 5 μm
Example 1-2 Pd, 5 μm
Example 1-3 Ni, 5 μm

Next, the round bar provided with the plating layer was inserted in the hole of the pipe material to combine the pipe material and the round bar (combination step).

Next, the pipe material combined with the round bar was swaged. The diameter of the pipe material was reduced by swaging, so that the pipe material and the round bar are brought into close contact (processing step). Then, the pipe material was cut to a length of 20 mm.

The cut pipe material was heat-treated in vacuum to diffusion bond the pipe material and the round bar (heat treatment step). The heat treatment temperature and time were selected as follows.
Example 1-1 1250° C., 1 hour
Example 1-2 1250° C., 1 hour
Example 1-3 1265° C., 1 hour

Next, a hole having a circular cross section was opened along the axis in the center of the round bar bonded to the pipe material with a drill and a reamer (hole forming step).

The multilayer pipe material having a hole formed in the center of the round bar was cut to a certain size with a wire saw (cutting step).

In Examples 1-4 and 1-5, the material of the outer layer was changed to Inconel 600, which is a Ni-based alloy, and two plating layers were formed over the outer circumferential surface of the round bar having a circular cross section made of 90 PtNi (mass %). In Example 1-4, the round bar was plated with Pd with a thickness of 2 μm, and was further plated with Ni with a thickness of 1 μm. In Example 1-5, the round bar was plated with Pt with a thickness of 4 μm, and was further plated with Ni with a thickness of 1 μm. In addition, the heat treatment temperature and time in the heat treatment step were set to 1150° C. and 1 hour for both Examples 1-4 and 1-5. The other steps and conditions were the same as those of Examples 1-1 to 1-3.

In Examples 1-6 to 1-9, the material of the outer layer was Inconel 601, which is a Ni-based alloy, and a plating layer of Ni with a thickness of 10 μm was formed over the outer circumferential surface of the round bar having a circular cross section made of 90 PtNi (mass %). Further, in the processing step, the combined first and second pipe materials and round bar were brought into close contact with each other in cold state. In the heat treatment step, hot isostatic pressing was performed in an Ar atmosphere. The heat treatment temperature, pressure and time were selected as follows. The other steps and conditions were the same as those of Examples 1-1 to 1-3.
Example 1-6 900° C., 150 MPa, 5 hours
Example 1-7 1000° C., 150 MPa, 5 hours
Example 1-8 1100° C., 150 MPa, 5 hours
Example 1-9 1200° C., 150 MPa, 5 hours

In Examples 1-10 to 1-13, the material of the outer layer was Inconel 601, which is a Ni-based alloy, and a plating layer of Au with a thickness of 10 μm was formed over the outer circumferential surface of the round bar having a circular cross section made of 90 PtNi (mass %). Further, in the processing step, the combined first and second pipe materials and round bar were brought into close contact with each other in cold state. In the heat treatment step, hot isostatic pressing was performed in an Ar gas atmosphere. The heat treatment temperature, pressure and time were selected as follows. The other steps and conditions were the same as those of Examples 1-1 to 1-3.
Example 1-10 900° C., 150 MPa, 5 hours
Example 1-11 1000° C., 150 MPa, 5 hours
Example 1-12 1100° C., 150 MPa, 5 hours
Example 1-13 1200° C., 150 MPa, 5 hours

### Example 2

In Example 2, a first pipe material having a hollow circular cross section made of Inconel 601 which is a Ni-based alloy was used as the outer layer, a second pipe material made of Pd with a thickness of 0.5 mm was used as the intermediate layer, and a round bar with a circular cross section made of 74.4Pt20IrNi (mass %) was used as the inner layer.

In the combination process, the second pipe material was inserted into the hole part of the first pipe material, and the round bar was inserted into the hole part of the second pipe material.

The heat treatment temperature and time in the heat treatment step were set to 1100° C. and 1 hour. The other steps and conditions were the same as those of Examples 1-1 to 1-3.

### Example 3

In Example 3, a plating of Au with a thickness of 1 μm was formed over the outer circumferential surface of the second pipe material as the intermediate layer made of Pd and having a thickness of 0.5 mm. The other steps and conditions were the same as those of Example 2.

### Comparative Examples

In Comparative Examples 1 and 2, the plating step in Examples 1-1 to 1-3 was omitted, and the heat treatment temperature and time in the heat treatment step were selected as 1270° C. and 1 hour, and 1250° C. and 1 hour, respectively. The other steps and conditions were the same as those of Examples 1-1 to 1-3.

The configurations of the examples and comparative examples, and their heat treatment conditions and judgment results are shown in Table 1.

### (Evaluation)

The cut surface of the pipe material was polished with a waterproof abrasive paper and buff, and the bonding property was evaluated by observing it using an electron microscope and an attached energy dispersive X-ray analyzer (hereinafter referred to as SEM/EDS), or by line analysis. Since the average atomic weight of the inner layer containing Pt is larger than that of the Ni-based alloy of the outer layer, it appears brighter. When there is a diffusion layer, that is, a composition gradient between the outer layer and the inner layer, the contrast appears as a gradation, and its thickness can also be measured. The thickness of the diffusion layer can also be measured by SEM/EDS line analysis.

The judgment results shown in Table 1 were derived as follows. When there was no non-diffusing part in the ring between layers, or it occupied 10% or less of the ring, the sample was rated as “◯”. When the non-diffusing part occupied more than 10% and less than 50% of the ring, the sample was rated as “Δ”, and “x” is used when it occupied 50% or more.

### (Results)

The pipe materials of Example 1 all exhibited the cross-sectional image of FIG. 2. In Examples 1-1 to 1-5, an intermediate layer (diffusion layer) having a thickness of 70 μm or greater was present between the outer layer and the inner layer. In the pipe materials of Examples 1-6 to 1-13 which were subjected to hot isostatic pressing, an intermediate layer (diffusion layer) having a thickness of 100 μm or greater at maximum was present between the outer layer and the inner layer. In any case, the components of the plating layer were detected when the intermediate layer was qualitatively analyzed with EDS.

The pipe material of Example 2 exhibited the cross-sectional image of FIG. 5. A diffusion layer with a thickness of 30 μm or greater was present between the outer layer (the first pipe material) and the intermediate layer (the second pipe material), and also between the intermediate layer (the second pipe material) and the inner layer. The thicknesses of the diffusion layers were measured by EDS line analysis.

Regarding the pipe material of Example 3, an intermediate layer (diffusion layer) with a thickness of 70 μm or greater was present between the outer layer (the first pipe material) and the intermediate layer (the second pipe material). The component Au of the plating layer was detected when the intermediate layer was qualitatively analyzed with EDS. Further, a diffusion layer with a thickness of 30 μm or greater was present between the intermediate layer (the second pipe material) and the inner layer. The thicknesses of the diffusion layers were measured by EDS line analysis.

On the other hand, regarding the pipe material of Comparative Example 1, despite the high heat treatment temperature of 1270° C., the diffusion was insufficient, and an interface with a clear contrast (non-diffusing part) remained in about 20% of the entire ring between the outer layer and the inner layer. Further, regarding the pipe material of Comparative Example 2, it exhibited the cross-sectional image of FIG. 3, and no diffusion layer was observed across the entire ring. No diffusion layer was confirmed by EDS line analysis either.

On the basis of the above results, it has become clear that the pipe material of the present disclosure is configured to promote interlayer diffusion as compared with pipe materials not provided with an intermediate layer. In addition, according to the pipe material of the present disclosure, sufficient diffusion was able to be obtained even at a lower heat treatment temperature as compared with pipe materials not provided with an intermediate layer.

TABLE 1

| | CONFIGURATION OF PIPE MATERIAL | | | | | |
|---|---|---|---|---|---|---|
| | | INTERMEDIATE LAYER | | | | |
| | OUTER LAYER | | SECOND | | HEAT | |
| | (FIRST PIPE | PLATING | PIPE | INNER | TREATMENT | |
| NO. | MATERIAL) | LAYER | MATERIAL | LAYER | CONDITIONS | RATING |
| 1-1 | INCONEL 601 | Au5 μm | N/A | 90PtNi | 1250° C., 1 h | ∘ |
| 1-2 | INCONEL 601 | Pd5 μm | N/A | 90PtNi | 1250° C., 1 h | ∘ |
| 1-3 | INCONEL 601 | Ni5 μm | N/A | 90PtNi | 1265° C., 1 h | ∘ |
| 1-4 | INCONEL 600 | Pd2 μm/ | N/A | 90PtNi | 1150° C., 1 h | ∘ |
| | | Ni1 μm | | | | |
| 1-5 | INCONEL 600 | Pt4 μm/ | N/A | 90PtNi | 1150° C., 1 h | ∘ |
| | | Ni1 μm | | | | |
| 1-6 | INCONEL 601 | Ni10 μm | N/A | 90PtNi | 900° C., | ∘ |
| | | | | | 150 MPa, 5 h | |
| 1-7 | INCONEL 601 | Ni10 μm | N/A | 90PtNi | 1000° C., | ∘ |
| | | | | | 150 MPa, 5 h | |
| 1-8 | INCONEL 601 | Ni10 μm | N/A | 90PtNi | 1100° C., | ∘ |
| | | | | | 150 MPa, 5 h | |
| 1-9 | INCONEL 601 | Ni10 μm | N/A | 90PtNi | 1200° C., | ∘ |
| | | | | | 150 MPa, 5 h | |
| 1-10 | INCONEL 601 | Au10 μm | N/A | 90PtNi | 900° C., | ∘ |
| | | | | | 150 MPa, 5 h | |
| 1-11 | INCONEL 601 | Au10 μm | N/A | 90PtNi | 1000° C., | ∘ |
| | | | | | 150 MPa, 5 h | |
| 1-12 | INCONEL 601 | Au10 μm | N/A | 90PtNi | 1100° C., | ∘ |
| | | | | | 150 MPa, 5 h | |
| 1-13 | INCONEL 601 | Au10 μm | N/A | 90PtNi | 1200° C., | ∘ |
| | | | | | 150 MPa, 5 h | |
| 2 | INCONEL 601 | N/A | Pd(t0.5) | 74.4Pt20IrNi | 1100° C., 1 h | ∘ |
| 3 | INCONEL 601 | Au1 μm | Pd(t0.5) | 74.4Pt20IrNi | 1100° C., 1 h | ∘ |
| COMPARATIVE | INCONEL 601 | N/A | N/A | 90PtNi | 1270° C., 1 h | Δ |
| EXAMPLE 1 | | | | | | |
| COMPARATIVE | INCONEL 601 | N/A | N/A | 90PtNi | 1250° C., 1 h | x |
| EXAMPLE 2 | | | | | | |

1. A pipe material comprising:
an outer layer made of a Ni-based alloy;
an inner layer provided inside the outer layer and made of a Pt-based alloy; and
an intermediate layer provided between the outer layer and the inner layer.

2. The pipe material according to claim 1, wherein the intermediate layer has a composition including Au, Ni, Ag, Pd, or Pt, or a combination of Ag and Pd, a combination of Pd and Ni, or a combination of Pt and Ni, in addition to the components of the outer layer and the inner layer.

3. The pipe material according to claim 1, wherein the intermediate layer is a layer made of Pd, a Pt—Ni alloy, or a Pd—Ni alloy, the outer layer and the intermediate layer are diffusion bonded, and the intermediate layer and the inner layer are diffusion bonded.

4. The pipe material according to claim 1, wherein the intermediate layer comprises a first intermediate layer and a second intermediate layer,
the first intermediate layer is provided inside the outer layer, and the second intermediate layer is provided between the first intermediate layer and the inner layer,
the first intermediate layer is a layer having a composition including Au, Cu, or Ni in addition to the components of the outer layer and the second intermediate layer, and
the second intermediate layer is a layer made of Pd, a Pt—Ni alloy, or a Pd—Ni alloy, and the second intermediate layer and the inner layer are diffusion bonded.

5. A method of producing the pipe material according to claim 2, the method comprising:
a plating step of forming, over the inner surface of a pipe material made of a Ni-based alloy corresponding to the outer layer, or over the outer surface of a round bar made of a Pt-based alloy corresponding to the inner layer, a plating layer of Au, Ni, Ag, Pd, or Pt, or two plating layers of a combination of Ag and Pd, two plating layers of a combination of Pd and Ni, or two plating layers of a combination of Pt and Ni;
a combining step of combining the pipe material and the round bar, one of which is provided with the one or two plating layers, such that the round bar is positioned radically inside a hole part of the pipe material;
a processing step of bringing the combined pipe material and round bar into close contact with each other;
a heat treatment step of bonding the pipe material and the round bar brought into close contact by heating them in a vacuum or inert gas atmosphere or by hot isostatic pressing in an inert gas atmosphere;
a hole forming step of forming a hole in the round bar which is bonded to the pipe material, by mechanical means, to turn it into a pipe material; and
a cutting step of cutting the pipe material provided with the hole.

6. A method of producing the pipe material according to claim 3, the method comprising:
a combining step of combining a first pipe material having a hollow circular cross section, made of a Ni-based alloy and corresponding to the outer layer, a second pipe material having a hollow circular cross section, made of Pd, a Pt—Ni alloy, or a Pd—Ni alloy and corresponding to the intermediate layer, and a round bar having a circular cross section, made of a Pt-based alloy and corresponding to the inner layer, such that the second pipe material is located inside a hole part of the first pipe material and the round bar is located inside a hole part of the second pipe material;
a processing step of bringing the combined first and second pipe materials and round bar into close contact with each other;
a heat treatment step of bonding the first and second pipe materials and the round bar brought into close contact by heating them in a vacuum or inert gas atmosphere or by hot isostatic pressing in an inert gas atmosphere;
a hole forming step of forming a hole in the round bar which is bonded to the pipe material, by mechanical means, to turn it into a pipe material; and
a cutting step of cutting the pipe material provided with the hole.

7. A method of producing the pipe material according to claim 4, the method comprising:
a plating step of providing a plating layer of Au, Cu, or Ni over the inner surface of a first pipe material having a hollow circular cross section, made of a Ni-based alloy and corresponding to the outer layer, or over the outer surface of a second pipe material having a hollow circular cross section, made of Pd, a Pt—Ni alloy, or a Pd—Ni alloy and corresponding to the intermediate layer;
a combining step of combining the first pipe material, the second pipe material, and a round bar having a circular cross section, made of a Pt-based alloy and corresponding to the inner layer, such that the second pipe material is located inside a hole part of the first pipe material and the round bar is located inside a hole part of the second pipe material;
a processing step of bringing the combined first and second pipe materials and round bar into close contact with each other;
a heat treatment step of bonding the first and second pipe materials and the round bar brought into close contact by heating them in a vacuum or inert gas atmosphere or by hot isostatic pressing in an inert gas atmosphere;
a hole forming step of forming a hole in the round bar which is bonded to the pipe material, by mechanical means, to turn it into a pipe material; and
a cutting step of cutting the pipe material provided with the hole.
